(19) United States
(12) Patent Application Publication
(10) Pub. No.: US 2009/0011137 A1
(43) Pub. Date: Jan. 8, 2009

(54) METHOD OF FORMING CRACKLE COATING ON BLIND SLAT

(75) Inventor: Po-Yu CHEN, Taichung (TW)

Correspondence Address: BROWDY AND NEIMARK, P.L.L.C.;624 NINTH STREET, NW, SUITE 300, WASHINGTON, DC, 20001-5303, US

(73) Assignee: Chin-Fu Chen, Taichung (TW)

(21) Appl. No.: 11/936,302

(22) Filed: Nov. 7, 2007

(30) Foreign Application Priority Data
Jul. 5, 2007 (TW) 96124548

(51) Int. Cl. B05D 3/00

(52) U.S. Cl. 427/532

(57) ABSTRACT

A method of forming a crackle pattern on a blind slat includes the steps of a) preparing a slat substrate, b) coating a surface of the slat substrate with a base coat, and c) coating a surface of the base coat with a crackle paint.

### BACKGROUND OF THE INVENTION

1. Field of the Invention

The present invention relates generally to blind slats for window covering and more particularly, to a method of forming a crackle pattern on a blind slat.

2. Description of the Related Art

In order to hide from sight, to block unwanted heat of the sun, or to reduce light to varying degrees, a window blind may be used and attached to the interior side of a window. A regular window blind is comprised of a set of blind slats prepared from wood, plastics, aluminum alloy, etc. A blind slat made of aluminum alloy has lightweight and fireproof characteristics. However, the monotonous outer appearance of aluminum alloy blind slats cannot attract people's eyes. Therefore, manufacturers may use transfer printing technique to cover the surface of an aluminum alloy blind slat with a design or grain pattern to give a visual effect. However, this coast tends to reflect light, causing the design or grain pattern not easy to be seen and lowering the sense of beauty of the outer appearance of the blind slat.

### SUMMARY OF THE INVENTION

The present invention has been accomplished under the circumstances in view. It is the main object of the present invention to provide a method of forming a crackle pattern on a blind slat, which can improve the slat quality and cause a sense of beauty.

To achieve this objective of the present invention, the method of forming a crackle pattern on a blind slat includes the steps of a) preparing a slat substrate, b) coating a base coat on the slat substrate, and c) coating a crackle paint on the base coat.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a processing flow chart of the method of forming a crackle pattern on a blind slat in accordance with an the exemplary embodiment of the present invention;

FIG. 2 is a schematic sectional drawing showing a slat substrate;

FIG. 3 is a schematic sectional drawing showing that a base coat is coated on the surface of the slat substrate;

FIG. 4 is a schematic sectional drawing showing that a crackle paint is coated on the base coat;

FIG. 5 is a schematic sectional drawing showing that a wood grain paint is coated on the crackle paint;

FIG. 6 is a schematic sectional drawing showing that a layer of gloss finish is coated on the wood grain paint, and FIG. 7 is a schematic top view of a blind slat having a crackle coating made according to the method of the present invention.

### DETAILED DESCRIPTION OF THE INVENTION

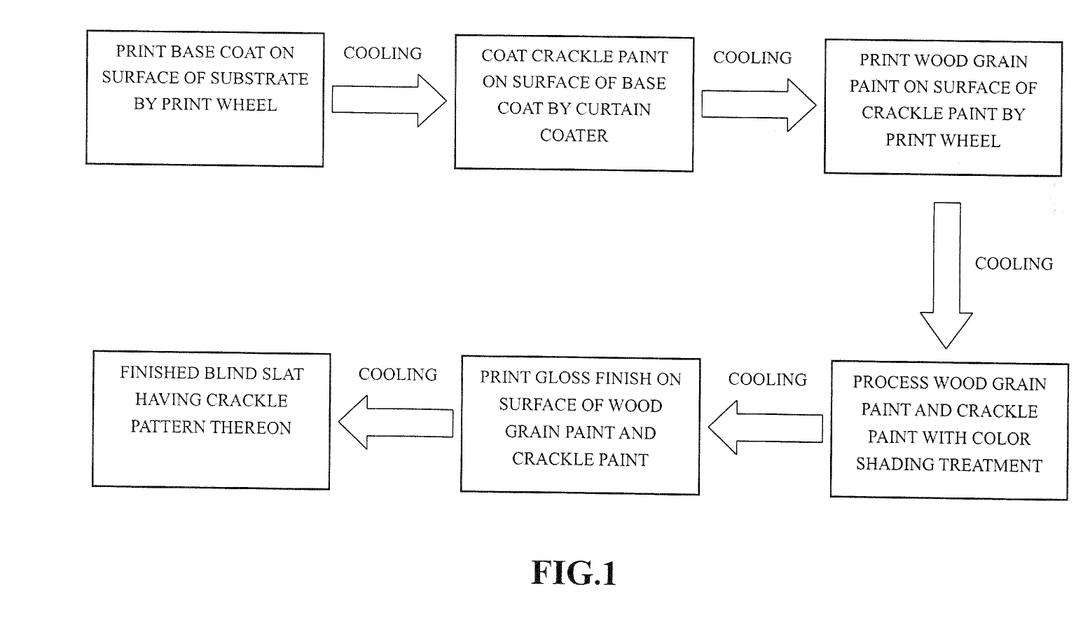

As shown in FIGS. 1-6, a method of forming a crackle pattern on a blind slat in accordance with an exemplary embodiment of the present invention comprises the following steps.

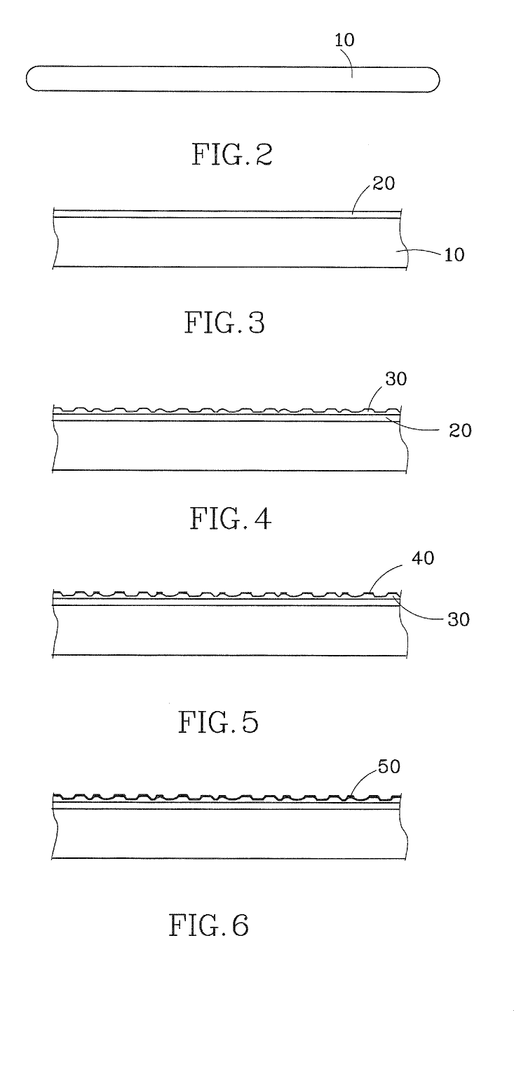

(a) Prepare a slat substrate 10 from wood or plastics subject to a predetermined thickness and width as shown in FIG. 2, and then put the slat substrate 10 in a conveyer (not shown), which delivers the slat substrate 10 forwards at a controlled speed.

(b) Use three print wheels (not shown) to print a layer of base coat 20 on the surface of the slat substrate 10 as shown in FIG. 3, and then dry the base coat 20 with cooling fans.

(c) Use a curtain coater (not shown) to coat a crackle paint 30 on the surface of the base coat 20 twice as shown in FIG. 4, and then dry the crackle paint 30 with cooling fans.

(d) Use two print wheels (not shown) to print a wood grain paint 40 on the surface of the crackle paint 30 as shown in FIG. 5, and then dry the wood grain paint 40 with cooling fans so that the surface of the slat substrate 10 shows an antique sense of beauty.

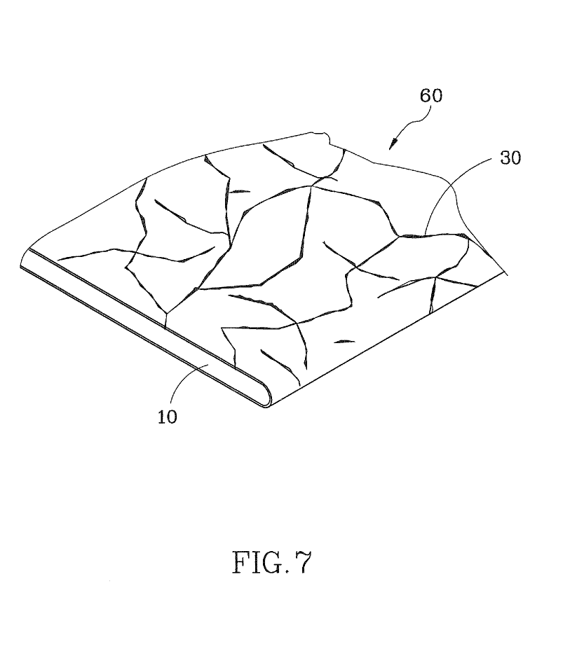

(e) Process the surface of the wood grain paint 40 and the crackle paint 30 with a color shading treatment by means of using two print wheels (not shown) to print a color agent on the surface of the wood grain paint 40 and the crackle paint 30 as shown in FIG. 6, and then dry the color agent with cooling fans, so as to emphasize the crackle pattern apparent.

(f) Use two print wheels to print a layer of gloss finish 50 on the surface of the wood grain paint 40 and the crackle paint 30 to enhance the surface quality of the slat substrate 10 and to protect the surface of the slat substrate 10 as shown in FIG. 6, and then dry the gloss finish 50 with cooling fans, so as to obtain a finished blind slat 60 having a crackle coating thereon, as shown in FIG. 7.

As stated above, the invention has the following features and advantages.

1. The surface of the slat substrate is coated with a layer of crackle paint, showing a unique visual effect that causes a sense of beauty.

2. The surface of the slat substrate is coated with a layer of wood grain paint giving an added value to the quality of the slat.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of forming a crackle pattern on a blind slat, comprising the steps of:
a) preparing a slat substrate;
b) coating a surface of the slat substrate with a base coat; and
c) coating a surface of the base coat with a crackle paint.

2. The method of claim 1, wherein the slat substrate prepared in step a) is obtained from wood.

3. The method of claim 1, wherein the slat substrate prepared in step a) is obtained from plastics.

4. The method of claim 1, wherein the crackle paint is coated twice on the surface of the base paint in step c).

5. The method of claim 1, further comprising a step of:
d) coating a layer of wood grain paint on a surface of the crackle paint.

6. The method of claim 5, further comprising a step of:
e) processing the wood grain paint and the crackle paint with a color shading treatment.

7. The method of claim 6, further comprising a step of:
f) coating a layer of gloss finish on the wood grain paint and the crackle paint.
